(19) United States
(12) Patent Application Publication
(10) Pub. No.: US 2024/0242276 A1
(43) Pub. Date: Jul. 18, 2024

(54) Blockchain-Based System for Management of Digital Tokens

(71) Applicant: Bank of America Corporation, Charlotte, NC (US)

(72) Inventor: Siten Sanghvi, Westfield, NJ (US)

(21) Appl. No.: 18/097,766

(22) Filed: Jan. 17, 2023

(51) Int. Cl. G06Q 40/04; G06Q 20/36; G06Q 20/38

(52) U.S. Cl. CPC G06Q 40/04; G06Q 20/3678; G06Q 20/3827; G06Q 20/389; G06Q 2220/00

(57) ABSTRACT

Aspects of this disclosure relate to a blockchain system for recording, querying and modifying transactions. In an arrangement, the blockchain system may correspond to a decentralized computing system for facilitating direct transactions between users, without involving a third party. The blockchain system may additionally be associated with a cryptocurrency that may be used for facilitating the transactions.

### TECHNICAL FIELD

Aspects of the disclosure relate to blockchain-based systems, and more specifically, to use of blockchain tokens for tracking, modifying, or transferring digital tokens.

### BACKGROUND

Blockchain-based technologies have seen increasing use for a wide range of applications. Secure, immutable, and distributed storage of information, and decentralized validation are some of the aspects that have led to increasing adoption of these technologies across a range of application areas. The most widespread and visible application of blockchains is in the domain of crypto-currency. However, the technology may be used for any application where decentralized and distributed operation is desirable.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues associated with management of blockchain systems for management of digital tokens. One or more of the aspects herein are described with reference to use of a blockchain for digital tokens for tracking stock ownership, purchases, and/or shareholder resolutions. Additional aspects described herein may relate to the use of smart contracts for stock token issuance.

In accordance with one or more arrangements, a computing platform comprising a processor and memory storing computer-readable instructions may perform, based on execution of the instructions one or more processes. The computing platform may receive, from a computing device, a request for stock purchase. The request may indicate a first quantity of shares of the stock, a value for each share, and an identifier associated with the stock. The computing platform may generate a first token indicating the first quantity of shares, the identifier associated with the stock, and a first wallet identifier associated with a user of the computing device. The computing platform may create a block for inclusion into a blockchain. The creating the block may comprise hashing at least the first token and a hash value of a first immediately preceding block in the blockchain to generate a first hash value. The computing platform may transmit the block for addition to respective local copies of the blockchain at other computing nodes. The computing platform may receive, from a second computing device, a second request for stock purchase. The second request may indicate a second quantity of shares of the stock, a second value for each share, and the identifier associated with the stock. The computing platform may generate at least two tokens comprising a second token and a third token. The second token may indicate the second quantity of shares, the identifier associated with the stock, and a second wallet identifier associated with a user of the second computing device. The third token may indicate a third quantity of shares, the identifier associated with the stock, and the first wallet identifier. The third quantity may be equal to a difference between the first quantity and the second quantity. The computing platform may create a second block, for inclusion into the blockchain. The creating the block may comprise hashing at least the second token, the third token, and a hash value of a second immediately preceding block in the blockchain to generate a second hash value. The computing platform may transmit the second block for addition to the blockchain.

In at least some arrangements, the computing platform may generate a fourth token indicating a reduction in a cryptocurrency balance associated with the first wallet identifier. In this case, the creating the block may comprise hashing at least the first token, the fourth token, and the hash value of the first immediately preceding block in the blockchain. The cryptocurrency balance may be equal to a difference between an initial balance associated with the first wallet identifier and a total value of the stock purchase associated with the request for stock purchase. The generating the first token and the fourth token may be based on execution of a smart contract.

In at least some arrangements, the computing platform may receive an indication of a third quantity of shares of the stock associated with the first wallet identifier and a stake duration. The computing platform may, based on expiration of the stake duration without a reduction in a quantity of shares of the stock associated with the first wallet identifier, generate a fourth token indicating an increase in a cryptocurrency balance associated with the first wallet identifier.

In at least some arrangements, the receiving the request for the stock purchase may comprise receiving a smart contract operation request for the stock purchase. The generating the first token may be based on execution, of a smart contract stored in the blockchain, in response to receiving the smart contract operation request.

In at least some arrangements, the second request may comprise an indication of the first wallet identifier. The computing platform may send, based on the indication of the first wallet identifier in the second request, a purchase request to the computing device. The generating the second token and the third token may be based on receiving an indication of approval from the computing device.

In at least some arrangements, an immediately preceding block may be a current latest block of the blockchain. In at least some arrangements, the computing platform may be associated with a computing node in a network comprising a plurality of computing nodes. In at least some arrangements, the computing platform may add the block to a local copy of the blockchain. The block may comprise a nonce value that, when hashed with a digest that combines the first token and the hash value of the first immediately preceding block, generates the first hash value comprising a predetermined number of consecutive alphanumerical characters at a predetermined position.

These features, along with many others, are discussed in greater detail below.

### BRIEF DESCRIPTION OF THE DRAWINGS

FIG. 1 depicts an illustrative example of decentralized P2P computer system, in accordance with one or more example arrangements;

FIG. 2A shows an example full node computing device, in accordance with one or more example arrangements;

FIG. 2B shows an example lightweight node computing device, in accordance with one or more example arrangements;

FIG. 3 shows an example of a computing system environment, in accordance with one or more example arrangements;

FIG. 4 shows additional examples aspects of the present disclosure relating to blockchain-based system, in accordance with one or more example arrangements;

FIG. 5 shows an event sequence for blockchain management, in accordance with one or more example arrangements; and

FIGS. 6A-6D show example graphical user interfaces (GUIs) associated with a distributed application for facilitating transactions.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect. The examples and arrangements described are merely some example arrangements in which the systems described herein may be used. Various other arrangements employing aspects described herein may be used without departing from the invention.

The disclosure provided herein is described, at least in part, in relation to a computing system specialized for the purpose of managing a blockchain. The computing system may be a centralized or a decentralized peer-to-peer (e.g., P2P) system. A decentralized P2P system may be comprised of computing devices (e.g., multiple nodes) that are distributed in multiple locations across a geographical area (as opposed to a single location such as a business or company). The computing devices/nodes may be associated with different businesses or companies. A centralized computing system may comprise of computing device(s)/server(s) that may be associated with a single company and which may operate as a single node. The computing device(s) may manage a blockchain, which may be a data structure used to store information related to the system. More specifically, the blockchain may be a chronological linkage of data elements (e.g., blocks) which store data records relating to the computing system.

While in practice the term “blockchain” may hold a variety of contextually derived meanings, the term blockchain, as used herein, refers to a concatenation of sequentially dependent data elements (e.g., blocks) acting as a data ledger that stores records relating to a computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (e.g., IoT), prediction platforms, elections, records, currency exchange and remittance, P2P transfers, ride sharing, trading platforms, and real estate, precious metal, and work of art registration and transference, among others.

A user may access the computing system through a specialized “wallet” that serves to uniquely identify the user and enable the user to perform various functions. Through the wallet, the user may be able to hold tokens, funds, or any other asset in the blockchain. Furthermore, the user may be able to use the wallet to request performance of network-specific functions such as fund, token, and/or asset transfers. An administrative user may also access the computing system to issue tokens, burn tokens, split tokens, and/or the like, on behalf of one or more users. The computing device(s) forming the computing system may perform network-specific functions requested by the user or administrative user. In some arrangements, the network-specific functions may be performed in accordance with smart contract operations as programed within the blockchain. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

A token may represent a unit of cryptocurrency as recorded by the blockchain or may be used to store any other type of information in the blockchain. The blockchain may record a balance sheet transaction. For example, a user may have a wallet which reflects that the user has five tokens associated with the blockchain. The user may provide a request to transfer the five tokens to a user or an enterprise organization (e.g., a banking institution) who may also have a wallet. One or more computing devices forming the computing system may perform the request and transfer the five tokens from the wallet of the user to the wallet of the enterprise organization. In doing so, a block may be created by computing device(s) of the computing system. The block may store data indicating that the five tokens were transferred from the wallet of the user to the wallet of the enterprise organization. The computing device(s) may add the block to the blockchain. At such a point, the wallet of the user may reflect the transfer of the five tokens to the wallet of the enterprise organization, and may indicate a balance of zero. The wallet of the enterprise organization, however, may also reflect the transfer of the five tokens and may have a balance equal to a sum of five tokens and an initial balance.

The blockchain may further be associated with a distributed application for facilitating purchase and sale of stocks. For example, a user may request purchase of stocks via the distributed application. One or more computing devices forming the computing system may perform the request and issue a token recording purchase of stocks by the user. In doing so, a block may be created by computing device(s) of the computing system. The block may store data indicating that the requested stocks were issued/transferred to a wallet associated with the user. The computing device(s) may add the block to the blockchain.

In more detail, the computing system may be specialized for the purpose of managing a distributed ledger, such as a private blockchain or a public blockchain, through the implementation of digital cryptographic hash functions, consensus algorithms, digital signature information, and network-specific protocols and commands. The computing system may comprise one or more computing devices, either of a heterogeneous or homogenous type, which serve as network node(s) (e.g., full nodes and/or lightweight nodes) to create and sustain computing network (e.g., a centralized or a decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions in a decentralized network, such as balance sheet transactions and smart contract operations, one or more full nodes forming the computing network may execute the one or more cryptographic hash functions, consensus algorithms, and network-specific protocols to register a requested network function on the blockchain. In some instances, a plurality of network function requests may be broadcasted across at least a portion of the full nodes of the decentralized network, aggregated through execution of the one or more digital cryptographic hash functions, and validated by performance of the one or more consensus algorithms to generate a single work unit (e.g., block), which may be added in a time-based, chronological manner to the blockchain through performance of network-specific protocols. In centralized networks, a single full node may perform the balance sheet transaction and/or smart contract operation, and record the transactions or operations within the blockchain.

A “private blockchain” may refer to a blockchain in which only authorized computing devices are permitted to act as node(s) and have access to the private blockchain. In some instances, the private blockchain may be viewable and/or accessible by authorized computing devices which are not participating as node(s) within the private network, but still have proper credentials. The private blockchain may be centralized (e.g., comprising a single node associated with an enterprise organization) or may be decentralized (e.g., comprising a plurality of nodes associated with multiple enterprise organizations). A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

A “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations” and “balance sheet transaction.” A smart contract operation, as used herein, may describe one or more operations performed by a “smart contract,” which may be one or more algorithms and/or programs associated with/stored in one or more nodes within a decentralized P2P network. A balance sheet transaction may describe one or more changes to data holdings associated with one or more nodes within a decentralized network.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network.

Current systems for issuing/trading stocks comprise centralized exchanges. Stock trading and associated operations (e.g., such as shareholder resolutions) may result in significant latencies and delays. For example, a user requesting stock purchase may need to request the purchase via a broker and trade is initiated and settled via the exchange. Current mechanisms for settling a transaction via an exchange may require 1-2 days for completion.

The various features associated with distributed applications, smart contracts, and blockchain may advantageously facilitate decentralized stock trading. Decentralized stock trading may substantially reduce delays associating with trading stocks. Further, decentralized operation may additionally improve transparency and also benefit people to raise funds for establishing new enterprises without needing to use exchanges for stock issue. Various examples herein describe the use of tokens for storing a record of asset/stock purchase, sale, in the blockchain. The blockchain, and its associated computing network/devices, may also be used to record/execute smart contracts for the purposes of issuing/trading stocks, including appropriate checks and balances into the trading mechanism, and/or implementing shareholder voting. The blockchain-based system may also be used to transparently record a history of transactions, ensuring availability for regulatory purposes/audits.

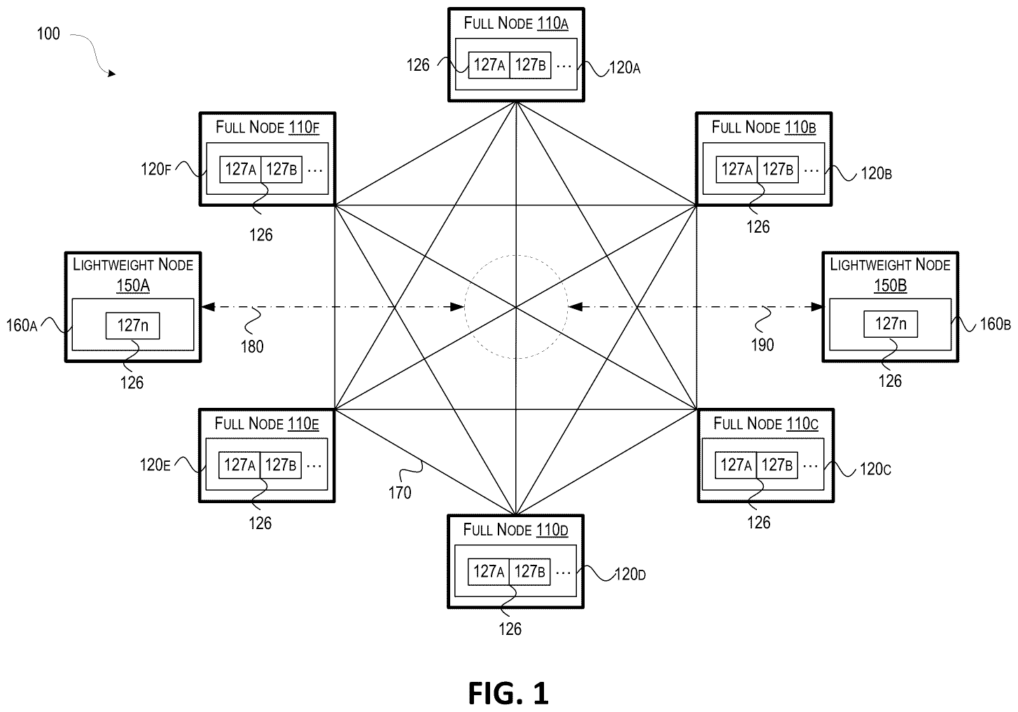

FIG. 1 depicts an illustrative example of decentralized P2P computer system 100 that may be used in accordance with one or more illustrative aspects described herein. Decentralized P2P computer system 100 may include a plurality of full node computing devices 110A, 110B, 110C, 110D, 110E, and 110F and lightweight node computing devices 150A and 150B. While a particular number of full node computing devices and lightweight node computing devices are depicted in FIG. 1, it should be understood that a number of full node computing devices and/or lightweight node computing devices greater or less than that of the depicted full node computing devices and lightweight node computing devices may be included in decentralized P2P computer system 100. Accordingly, any additional full node computing devices and/or lightweight node computing devices may respectively perform in the manner described below in regard to full node computing devices 110A-110F and lightweight node computing devices 150A and 150B in decentralized P2P computer system 100.

Each of full node computing devices 110A-110F may operate in concert to create and maintain decentralized P2P network 170 of decentralized P2P computer system 100. In creating decentralized P2P network 170 of decentralized P2P computer system 100, processors, ASIC devices, and/or graphics processing units (e.g., GPUs) of each full node computing device 110A-110F may execute network protocols which may cause each full node computing device 110A-110F to form a communicative arrangement with the other full node computing devices 110A-110F in decentralized P2P computer system 100 and create decentralized P2P network 170. Furthermore, the execution of network protocols by the processors, ASIC devices, and/or graphics processing units (e.g., GPUs) of full node computing devices 110A-110F may cause full node computing devices 110A-110F to execute network functions related to blockchain 126 and thereby maintain decentralized P2P network 170.

Lightweight node computing devices 150A and 150B may request execution of network functions related to blockchain 126 in decentralized P2P network 170. In order to request execution of network functions, such as balance sheet transaction and/or smart contract operations, processors of lightweight node computing devices 150A and 150B may execute network commands to broadcast the network functions to decentralized P2P network 170 comprising full node computing devices 110A-110F. For example, the balance sheet transaction or the smart contract operation may be used to execute a cryptocurrency transfer (e.g., for stock purchase), issuing/transfer of shares, passing shareholder resolutions, etc., as described herein.

For example, lightweight node computing device 150A may request execution of a balance sheet transaction related to blockchain 126 in decentralized P2P network 170, which may entail a data transfer from a private/public key associated with lightweight node computing device 150A to a private/public key associated with lightweight node 150B. In doing so, processors of lightweight node computing device 150A may execute network commands to broadcast balance sheet transaction network function request 180 to decentralized P2P network 170. The balance sheet transaction may be for transfer of cryptocurrency (e.g., from a public key associated with the lightweight computing device 150A to a public key associated with the lightweight computing device 150B). Balance sheet transaction network function request 180 may include details about the data transfer such as data type (e.g., a cryptocurrency type) and amount, as well as a data transfer amount to full node computing devices 110A-110F of decentralized P2P network 170 for executing balance sheet transaction network function request 180. Balance sheet transaction network function request 180 may further include the public key associated with lightweight node computing device 150B. Processors of lightweight node computing device 150A may execute digital signature algorithms to digitally sign balance sheet transaction network function request 180 with the private key associated with lightweight node computing device 150A.

At decentralized P2P network 170, balance sheet transaction network function request 180 may be broadcasted to each of full node computing devices 110A-110F through execution of network protocols by full node computing devices 110A-110F. In order to execute balance sheet transaction network function request 180 and maintain inter-nodal agreement as to the state of blockchain 126, processors, ASIC devices, and/or GPUs of full node computing devices 110A-110F may execute network protocols to receive broadcast of the network function through a decentralized P2P network 170 and from lightweight node computing device 150A. Processors, ASIC devices, and/or GPUs of full node computing devices 110A-110F may execute hash functions to generate a digest of balance sheet transaction network function request 180. The resultant digest of balance sheet transaction network function request 180, in turn, may be hashed with the block hash of the most immediately preceding block of blockchain 126. Processors, ASIC devices, and/or GPUs of full node computing devices 110A-110F may execute consensus algorithms to identify a numerical value (e.g., nonce) corresponding to the particular executed consensus algorithm and related to the digest that combines the digest of the balance sheet transaction network function request 180 and the block hash of the most immediately preceding block of blockchain 126.

For example, in embodiments in which the consensus algorithm is proof of work (e.g., PoW), processors, ASIC devices, and/or GPUs of full node computing devices 110A-110F may perform a plurality of hashing operations to identify a nonce that, when hashed with the digest that combines the digest of the balance sheet transaction network function request 180 and the block hash of the most immediately preceding block of blockchain 126, produces a hash of a predetermined alphanumerical format. Such a predetermined alphanumerical format may include a predetermined number of consecutive alphanumerical characters at a predetermined position within the resultant digest that combines the nonce, digest of the balance sheet transaction network function request 180, and block hash of the most immediately preceding block of blockchain 126.

In embodiments in which the consensus algorithm is proof of stake (e.g., PoS), a private key associated with one of full node computing devices 110A-110F may be pseudo-randomly selected, based on balance sheet holdings associated with the public keys of full node computing devices 110A-110F, to serve as the nonce. For example, through execution of the POS consensus algorithm, full node computing devices 110A-110F are entered into a lottery in which the odds of winning are proportional to a balance sheet amount associated the public key of each of full node computing devices 110A-110F, wherein a larger balance sheet amount corresponds to a higher probability to win the lottery. The POS consensus algorithm may cause a full node computing device from full node computing devices 110A-110F to be selected, and the public key of the selected full node computing device to be used as the nonce.

In embodiments in which the consensus algorithm is delegated proof of stake (e.g., DPoS), a group of delegates are chosen from full node computing devices 110A-110F by each of computing devices 110A-110F, wherein full node computing devices 110A-110F are allowed to vote on delegates based on balance sheet holdings associated with the respective public keys. Full node computing devices 110A-110F, however, may not vote for themselves to be delegates. Once the group of delegates are chosen, the group of delegates from full node computing devices 110A-110F select a public key associated with one of full node computing devices 110A-110F to serve as the nonce. Again, each of the delegates are prohibited from selecting themselves and their respective public key from serving as the nonce.

In embodiments in which the consensus algorithm is practical byzantine fault tolerance algorithm (e.g., PBFT), each of full node computing devices 110A-110F are associated with a particular status and/or ongoing specific information associated with the respective public key of the full node computing devices. Each of full node computing devices 110A-110F receive a message through decentralized P2P network 170 based on network protocols. Based on the received message and particular status and/or ongoing specific information, each of full node computing devices 110A-110F perform computational tasks and transmit a response to the tasks to each of the other full node computing devices 110A-110F. A public key associated with a particular full node computing device from full node computing devices 110A-110F is selected by each of full node computing devices 110A-110F based on the response of the particular full node computing device best fulfilling criteria determined based on the network protocols.

The identification of the nonce enables processors, ASIC devices, and/or GPUs of the full node computing device from full node computing devices 110A-110F to create a new block with a block header (e.g., block hash), which is a digest that combines the digest of balance sheet transaction network function request 180, the block hash of the most immediately preceding block, and the identified nonce. Processors, ASIC devices, and/or GPUs of the full node computing device from full node computing devices 110A-110F may execute network protocols to add the new block to blockchain 126 and broadcast the new block to the other full node computing devices in the decentralized P2P network 170. In some arrangements, the new block may also be time-stamped at a time corresponding to the addition to blockchain 126. Furthermore, as a reward for adding the new block to blockchain 126, the full node computing device from full node computing devices 110A-110F may be allowed, per the network protocols, to increase a balance sheet holdings amount associated with itself by a predetermined amount. In some arrangements, each of full node computing devices 110A-110F may receive an equal portion of the data transfer amount specified by lightweight node computing device 150A for executing balance sheet transaction network function request 180. After the new block has been added to blockchain 126, balance sheet transaction network function request 180 may be considered to be executed and the data transfer from the private/public key associated with lightweight node computing device 150A to the private/public key associated with lightweight node 150B may be registered.

As stated above, in some arrangements, a plurality of network function requests may be broadcasted across decentralized network P2P network 170. Processors, ASIC devices, and/or GPUs of full node computing devices 110A-110F may execute network protocols to receive broadcast of each of the network functions, including balance sheet transaction network function request 180, through decentralized P2P network 170 and from the requesting entities, including lightweight node computing device 150A. Processors, ASIC devices, and/or GPUs of full node computing devices 110A-110F may execute hash functions to generate a hash tree (e.g., Merkle tree) of the requested network functions, which culminates in a single digest (e.g., root digest, root hash, and the like) that comprises the digests of each of the requested network functions, including balance sheet transaction network function request 180. The root digest of the requested network function, in turn, may be hashed with the block hash of the most immediately preceding block of blockchain 126. Processors, ASIC devices, and/or GPUs of full node computing devices 110A-110B may execute consensus algorithms in the manner described above to identify a nonce corresponding to the particular executed consensus algorithm and related to the digest that combines the root digest of the requested network functions and the block hash of the most immediately preceding block of blockchain 126. The identification of the nonce enables processors, ASIC devices, and/or GPUs of the full node computing device from full node computing devices 110A-110F to create a new block with a block header (e.g., block hash), which is a digest that combines the root digest of the network function requests, the block hash of the most immediately preceding block, and the identified nonce. Processors, ASIC devices, and/or GPUs of the full node computing device from full node computing devices 110A-110F may execute network protocols to add the new block to blockchain 126 and broadcast the new block to the other full node computing devices in the decentralized P2P network 170. In some arrangements, the new block may also be time-stamped at a time corresponding to the addition to blockchain 126. Furthermore, as a reward for adding the new block to blockchain 126, the full node computing device from full node computing devices 110A-110F may be allowed, per the network protocols, to increase a balance sheet holdings amount associated with itself by a predetermined amount. In some arrangements, each of full node computing devices 110A-110F may receive an equal portion of the data transfer amount specified by each of the network function requests. After the new block has been added to blockchain 126, each of the network functions requests, including balance sheet transaction network function request 180, may be considered to be executed and the data transfer from the private/public key associated with lightweight node computing device 150A to the private/public key associated with lightweight node 150B may be registered.

While the description provided above is made in relation to a balance sheet transaction involving lightweight node computing device 150A and lightweight node computing device 150B, it is to be understood that balance sheet transactions are not limited to lightweight node computing device 150A and lightweight node computing device 150B, but rather may be made across any of the full node computing devices and/or lightweight node computing devices in decentralized P2P system 100.

For another example, lightweight node computing device 150B may request a smart contract operation related to blockchain 126 in decentralized P2P network 170, which may facilitate a dual data transfer between a private/public key associated with lightweight node computing device 150B and a private/public key associated lightweight node computing device 150A. For example, the smart contract operation may correspond to issuance of shares to the public key associated with the lightweight computing device 150A). Processors of lightweight node computing device 150B may execute network commands to broadcast smart contract operation network function request 190 to decentralized P2P network 170. Smart contract operation network function request 190 may include details about the data transfer such as data type (e.g., stock identifier) and amount, as well as a data transfer amount to full node computing devices 110A-110F of decentralized P2P network 170 for executing smart contract operation network function request 190. Smart contract operation network function request 190 may further include the public key associated with the smart contract. Processors of lightweight node computing device 150B may execute digital signature algorithms to digitally sign smart contract operation network function request 190 with the private key associated with lightweight node computing device 150B.

At decentralized P2P network 170, smart contract operation network function request 190 may be broadcasted to each of full node computing devices 110A-110F through execution of network protocols by full node computing devices 110A-110F. In order to execute smart contract operation network function request 190 and maintain inter-nodal agreement as to the state of blockchain 126, processors, ASIC devices, and/or GPUs of full node computing devices 110A-110F may execute network protocols to receive broadcast of the network function through a decentralized P2P network 170 and from lightweight node computing device 150B. Processors, ASIC devices, and/or GPUs of full node computing devices 110A-110F may execute hash functions to generate a digest of smart contract operation network function request 190. The resultant digest of smart contract operation network function request 190, in turn, may be hashed with the block hash of the most immediately preceding block of blockchain 126. Processors, ASIC devices, and/or GPUs of full node computing devices 110A-110F may execute consensus algorithms to identify a nonce corresponding to the particular executed consensus algorithm and related to the digest that combines the digest of smart contract operation network function request 190 and the block hash of the most immediately preceding block of blockchain 126.

The identification of the nonce enables processors, ASIC devices, and/or GPUs of the full node computing device from full node computing devices 110A-110F to create a new block with a block header (e.g., block hash), which is a digest that combines smart contract operation network function request 190, the block hash of the most immediately preceding block, and the identified nonce. Processors, ASIC devices, and/or GPUs of the full node computing device from full node computing devices 110A-110F may execute network protocols to add the new block to blockchain 126 and broadcast the new block to the other full node computing devices in the decentralized P2P network 170. In some arrangements, the new block may also be time-stamped at a time corresponding to the addition to blockchain 126. Furthermore, as a reward for adding the new block to blockchain 126, the full node computing device from full node computing devices 110A-110F may, per the network protocols, increase a balance sheet holdings amount associated with itself by a predetermined amount. In some arrangements, each of full node computing devices 110A-110F may receive an equal portion of the data transfer amount specified by lightweight node computing device 150A for executing smart contract operation network function request 190. After the new block has been added to blockchain 126, smart contract operation request 190 may be considered to be executed and the data transfer from the private/public key associated with lightweight node computing device 150B to the private/public key associated with the smart contract may be registered.

The smart contract may be configured to hold the data transfer from the private/public key associated with lightweight node computing device 150B until fulfillment of certain predetermined criteria hardcoded into the smart contract is achieved. The smart contract may be configured such that it serves as an intermediate arbiter between entities within the decentralized P2P network 170 and may specify details of a dual data transfer between entities.

Lightweight node computing device 150A may also request a smart contract operation related to blockchain 126 in decentralized P2P network 170, which may conclude the dual data transfer between a private/public key associated lightweight node computing device 150A and a private/public key associated with lightweight node computing device 150B. Processors of lightweight node computing device 150A may execute network commands to broadcast the smart contract operation network function request to decentralized P2P network 170. The smart contract operation network function request may include details about the data transfer such as data type and amount, as well as a data transfer amount to full node computing devices 110A-110F of decentralized P2P network 170 for executing the smart contract operation network function request. The smart contract operation network function request may further include the public key associated with the smart contract. Processors of lightweight node computing device 150A may execute digital signature algorithms to digitally sign the smart contract operation network function request with the private key associated with lightweight node computing device 150A.

At decentralized P2P network 170, the smart contract operation network function request may be broadcasted to each of full node computing devices 110A-110F through execution of network protocols by full node computing devices 110A-110F. In order to execute the smart contract operation network function request and maintain inter-nodal agreement as to the state of blockchain 126, processors, ASIC devices, and/or GPUs of full node computing devices 110A-110F may execute network protocols to receive broadcast of the network function through a decentralized P2P network 170 and from lightweight node computing device 150A. Processors, ASIC devices, and/or GPUs of full node computing devices 110A-110F may execute hash functions to generate a digest of the smart contract operation network function request. The resultant digest of the smart contract operation network function request, in turn, may be hashed with the block hash of the most immediately preceding block of blockchain 126. Processors, ASIC devices, and/or GPUs of full node computing devices 110A-110F may execute consensus algorithms to identify a nonce corresponding to the particular executed consensus algorithm and related to the digest that combines the digest of the smart contract operation network function request and the block hash of the most immediately preceding block of blockchain 126.

The identification of the nonce enables processors, ASIC devices, and/or GPUs of the full node computing device from full node computing devices 110A-110F to create a new block with a block header (e.g., block hash), which is a digest that combines the smart contract operation network function request, the block hash of the most immediately preceding block, and the identified nonce. Processors, ASIC devices, and/or GPUs of the full node computing device from full node computing devices 110A-110F may execute network protocols to add the new block to blockchain 126 and broadcast the new block to the other full node computing devices in the decentralized P2P network 170. In some arrangements, the new block may also be time-stamped at a time corresponding to the addition to blockchain 126. Furthermore, as a reward for adding the new block to blockchain 126, the full node computing device from full node computing devices 110A-110F may be allowed, per the network protocols, to increase a balance sheet holdings amount associated with itself by a predetermined amount. In some arrangements, each of full node computing devices 110A-110F may receive an equal portion of the data transfer amount specified by lightweight node computing device 150A for executing the smart contract operation network function request. After the new block has been added to blockchain 126, the smart contract operation transaction network function request 190 may be considered to be executed and the data transfer from the private/public key associated with lightweight node computing device 150A to the private/public key associated with the smart contract may be registered.

When the smart contract receives the data value from each of lightweight node computing device 150A and lightweight node computing device 150B, the smart contract may transfer the data value from lightweight node computing device 150A to lightweight node computing device 150B and the data value from lightweight node computing device 150B to lightweight node computing device 150A.

While the description provided above was made in relation to lightweight node computing device 150A and lightweight node computing device 150B, it should be understood that any of the full node computing devices and lightweight node computing devices in decentralized system 100 may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer.

Decentralized P2P computer system 100 may provide technological advantages. For example, by distributing storage of blockchain 126 across multiple full node computing devices 110A-110F, decentralized P2P computer system 100 may not provide a single point of failure for malicious attack. In the event that any of the full node computing devices 110A-110F are compromised by a malicious attacker, decentralized P2P computer system 100 may continue to operate unabated as data storage of blockchain 126 and network processes are not controlled by a singular entity.

Furthermore, by utilizing blockchain data structure 126, decentralized P2P system 100 may provide technological improvements to conventional decentralized P2P systems in regard to byzantine fault tolerance stemming from an unreliable and/or malicious full node acting in decentralized P2P network 170 to undermine the work efforts of the other nodes. For example, in coordinating action between full node computing devices 110A-110F in relation to a similar computational task (e.g., consensus algorithm), a malicious node would need to have computational power greater than the combined computational power of each of the other full node computing devices in decentralized P2P network 170 to identify the nonce and thereby be able to modify blockchain 126. As such, the likelihood that a malicious node could subvert decentralized P2P network 170 and enter falsified data into blockchain 170 is inversely proportional to the total computational power of decentralized P2P system 100. Therefore, the greater the total computational power of decentralized P2P system 100, the less likely that a malicious node could subvert decentralized P2P network 170 and undermine blockchain 126.

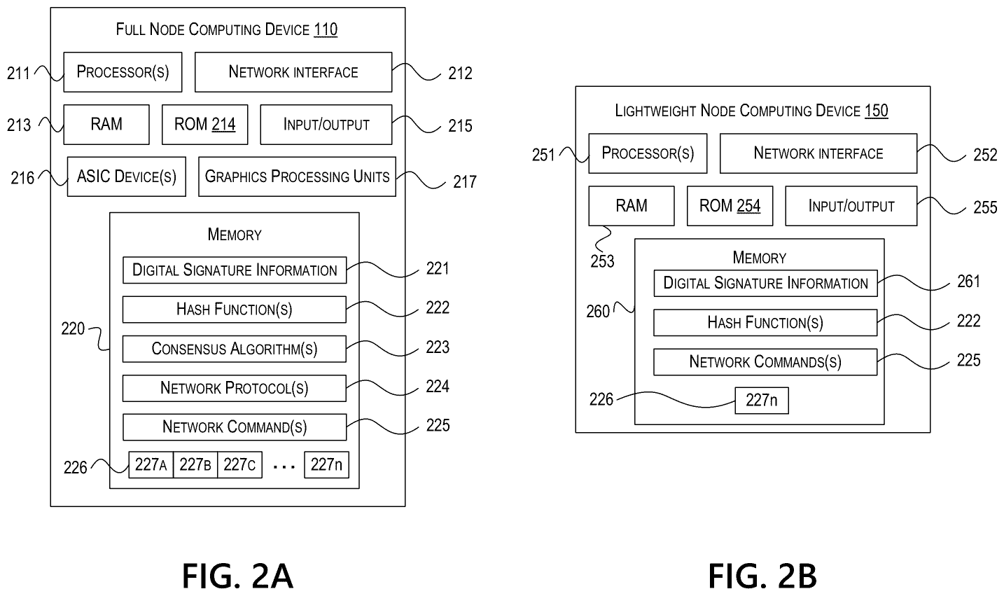

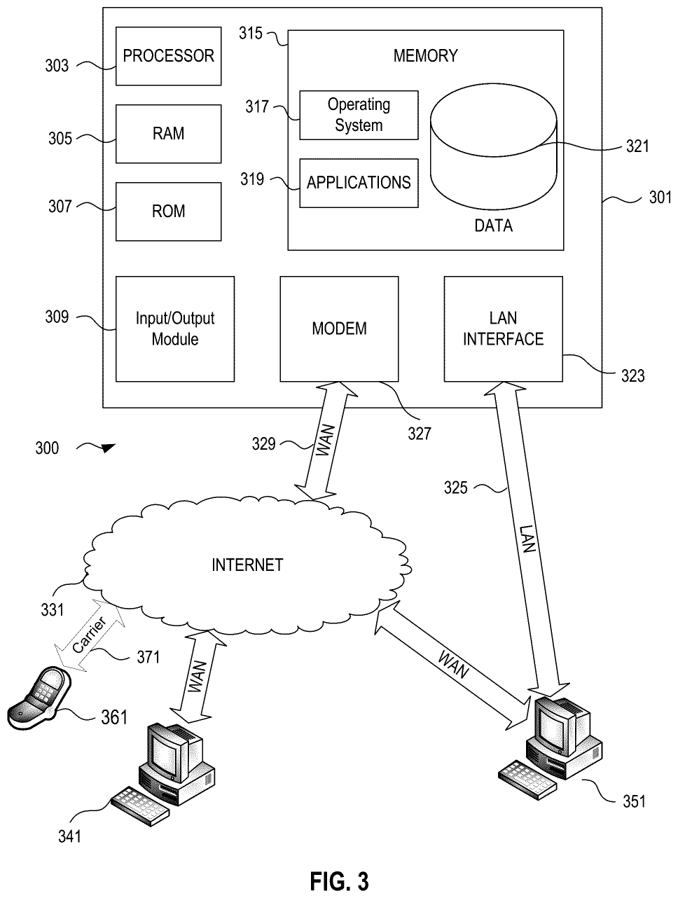

FIG. 2A depicts an illustrative example of a full node computing device 110 that may be used in accordance with one or more illustrative aspects described herein. Full node computing device 110 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, full node computing device 110 may be configured to operate in a decentralized P2P network and may request execution of network functions and/or to execute requested network functions and maintain inter-nodal agreement as to the state of a blockchain of the decentralized P2P network.

Full node computing device 110 may include one or more processors 211, which control overall operation, at least in part, of full node computing device 110. Full node computing device 110 may further include random access memory (RAM) 213, read only memory (ROM) 214, network interface 212, input/output interfaces 215 (e.g., keyboard, mouse, display, printer, and the like), and memory 220. Input/output (I/O) 215 may include a variety of interface units and drives for reading, writing, displaying, and/or printing data or files. In some arrangements, full node computing device 110 may further comprise specialized hardware components such as application-specific integrated circuit (e.g., ASIC) devices 216 and/or graphics processing units (e.g., GPUs) 217. Such specialized hardware components may be used by full node computing device 110 in performing one or more of the processes involved in the execution of requested network functions and maintenance of inter-nodal agreement as to the state of a blockchain. Full node computing device 110 may further store in memory 220 operating system software for controlling overall operation of the full node computing device 110, control logic for instructing full node computing device 110 to perform aspects described herein, and other application software providing secondary, support, and/or other functionality which may or might not be used in conjunction with aspects described herein.

Memory 220 may also store data and/or computer executable instructions used in performance of one or more aspects described herein. For example, memory 220 may store digital signature information 221 and one or more hash functions 222, consensus algorithms 223, network protocols 224, and network commands 225. In some arrangements, digital signature information 221, hash functions 222, and/or network commands 225 may comprise a wallet of full node computing device 110. Memory 220 may further store blockchain 226. Each of digital signature information 221, hash functions 222, consensus algorithms 223, network protocols 224, and network commands 225 may be used and/or executed by one or more processors 211, ASIC devices 216, and/or GPUs 217 of full node computing device 110 to create and maintain a decentralized P2P network, request execution of network functions, and/or execute requested network functions and maintain inter-nodal agreement as to the state of blockchain 226.

For example, in order to create and maintain a decentralized P2P network, processors 211, ASIC devices 216, and/or GPUs 217 of full node computing device 110 may execute network protocols 225. Execution of network protocols 225 may cause full node computing device 110 to form a communicative arrangement with other full node computing devices and thereby create a decentralized P2P network. Furthermore, the execution of network protocols 225 may cause full node computing device 110 to maintain the decentralized P2P network through the performance of computational tasks related to the execution of network requests related to a blockchain such as blockchain 226. As will be described in detail below, the execution of such computational tasks (e.g., hash functions 222, consensus algorithms 223, and the like) may cause full node computing device 110 to maintain inter-nodal agreement as to the state of a blockchain with other full node computing devices comprising the decentralized P2P network.

In order to request execution of network functions, such as balance sheet operations and/or smart contract operations, processors 211, ASIC devices 216, and/or GPUs 217 of full node computing device 110 may execute network commands 225 to broadcast the network function to a decentralized P2P network comprising a plurality of full nodes and/or lightweight nodes. The request may be digitally signed by full node computing device 110 with usage of the private/public key information and through execution of the digital signature algorithms of digital signature information 221.

In order to execute requested network functions and maintain inter-nodal agreement as to the state of a blockchain, processors 211, ASIC devices 216, and/or GPUs 217 of full node computing device 110 may execute network protocols 224 to receive a broadcast of a requested network function through a decentralized P2P network and from a requesting entity such as a full node or lightweight node. Processors 211, ASIC devices 216, and/or GPUs 217 of full node computing device 110 may execute hash functions 222 to generate a digest of the requested network function. The resultant digest of the requested network function, in turn, may be hashed with the block hash of the most immediately preceding block of the blockchain. As will be described in further detail below, processors 211, ASIC devices 216, and/or GPUs 217 of full node computing device 110 may execute consensus algorithms 223 to identify a numerical value (e.g., nonce) corresponding to the particular executed consensus algorithm and related to the digest that combines the digest of the requested network function and the block hash of the most immediately preceding block of the blockchain. The identification of the numerical value enables processors 211, ASIC devices 216, and/or GPUs 217 of full node computing device 110 to create a new block with a block header (e.g., block hash), which is a digest that combines the digest of the requested network function, the block hash of the most immediately preceding block, and the identified nonce. Processors 211, ASIC devices 216, and/or GPUs 217 of full node computing device 110 may add the new block to the blockchain based on network protocols 224 and broadcast the new block to the other nodes in the decentralized P2P network.

As stated above, in some arrangements, a plurality of network function requests may be broadcasted across the decentralized P2P network. Processors 211, ASIC devices 216, and/or GPUs 217 of full node computing device 110 may execute network protocols 224 to receive broadcast of each of the network functions through the decentralized P2P network and from the requesting entities. Processors 211, ASIC devices 216, and/or GPUs 217 of full node computing device 110 may execute hash functions 222 to generate a hash tree (e.g., Merkle tree) of the requested network functions, which culminates in a single digest (e.g., root digest, root hash, and the like) that comprises the digests of each of the requested network functions. The root digest of the requested network function, in turn, may be hashed with the block hash of the most immediately preceding block of the blockchain. Processors 211, ASIC devices 216, and/or GPUs 217 of full node computing device 110 may execute consensus algorithms 223 to identify a numerical value (e.g., nonce) corresponding to the particular executed consensus algorithm and related to the digest that combines the root digest of the requested network functions and the block hash of the most immediately preceding block of the blockchain. The identification of the numerical value enables processors 211, ASIC devices 216, and/or GPUs 217 of full node computing device 110 to create a new block with a block header (e.g., block hash), which is a digest that combines the root digest of the requested network functions, the block hash of the most immediately preceding block, and the identified nonce. Processors 211, ASIC devices 216, and/or GPUs 217 of full node computing device 110 may add the new block to the blockchain based on network protocols 224 and broadcast the new block to the other nodes in the decentralized P2P network.

Furthermore, memory 220 of full node computing device 110 may store blockchain 226. Blockchain 226 may include a blocks 227A, 227B, 227C, . . . 227n, wherein block 227A represents the first block (e.g., genesis block) of blockchain 226 and block 227n represents the most immediate block of blockchain 226. As such, the blockchain 226, which may be a replica or copy of the blockchain of the decentralized P2P network in which full node computing device 110 operates, may be a full or complete copy of the blockchain of the decentralized P2P network. Each of the blocks within blockchain 226 may include information corresponding to the one or more network functions executed by the decentralized P2P network. As such, blockchain 226 as stored in memory 220 of full node computing device 110 may comprise the totality of network functions executed by the decentralized network.

FIG. 2B depicts an illustrative example of a lightweight node computing device 150 that may be used in accordance with one or more illustrative aspects described herein. Lightweight node computing device 150 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, lightweight node computing device 150 may operate in a decentralized P2P network and may be configured to request execution of network functions through the decentralized P2P network. As such, lightweight node computing device 150 may be different than full node computing device 110 in that it is not configured to execute network functions and/or operate to maintain a blockchain of a decentralized P2P network. In other aspects, lightweight node computing device 150 may have substantially the same physical configuration as full node computing device 110, but configured with different programs, software, and the like.

Lightweight node computing device 150 may include one or more processors 251, which control overall operation of lightweight node computing device 150. Lightweight node computing device 150 may further include random access memory (RAM) 253, read only memory (ROM) 254, network interface 252, input/output interfaces 255 (e.g., keyboard, mouse, display, printer, and the like), and memory 260. Input/output (I/O) 255 may include a variety of interface units and drives for reading, writing, displaying, and/or printing data or files. Lightweight node computing device 150 may store in memory 260 operating system software for controlling overall operation of the lightweight node computing device 150, control logic for instructing lightweight node computing device 150 to perform aspects described herein, and other application software providing secondary, support, and/or other functionality which may or might not be used in conjunction with aspects described herein.

In comparison to full node computing device 110, lightweight node computing device 150 might not include, in some instances, specialized hardware such as ASIC devices 216 and/or GPUs 217. Such is the case because lightweight node computing device 150 might not be configured to execute network functions and/or operate to maintain a blockchain of a decentralized P2P network as is full node computing device 110. However, in certain arrangements, lightweight node computing device 150 may include such specialized hardware.

Memory 260 of lightweight node computing device 150 may also store data and/or computer executable instructions used in performance of one or more aspects described herein. For example, memory 260 may store digital signature information 261 and one or more hash functions 222 and network commands 225. In some arrangements, digital signature information 261, hash functions 222, and/or network commands 225 may comprise a wallet of lightweight node computing device 150. Each of hash functions 222 and network commands 225 stored in memory 260 of lightweight node computing device 150 may be respectively similar and/or identical to hash functions 222 network commands 225 stored in memory 220 of full node computing device 110.

In regard to the digital signature information, each of digital signature information 261 stored in memory 260 of lightweight node computing device 150 and digital signature information 221 stored in memory 220 of full node computing device 110 may comprise similar and/or identical digital signature algorithms. However, the private/public key information of digital signature information 261 stored in memory 260 of lightweight node computing device 150 may be different than that of the private/public key information of digital signature information 221 stored in memory 220 of full node computing device 110. Furthermore, the private/public key information of each node, whether full or lightweight, in a decentralized P2P computing network may be unique to that particular node. For example, a first node in a decentralized P2P computing network may have first private/public key information, a second node may have second private/public key information, a third node may have third private/public key information, and so on, wherein each of the private/public key information is unique to the particular node. As such, the private/public key information may serve as a unique identifier for the nodes in a decentralized P2P computing network.

Each of digital signature information 261, hash functions 222, and network commands 225 may be used and/or executed by one or more processors 251 of lightweight node computing device 150 to request execution of network functions in a decentralized P2P network. For example, in order to request execution of network functions, such as balance sheet operations and/or smart contract operations, processors 251 of lightweight node computing device 150 may execute network commands 225 to broadcast the network function to a decentralized P2P network comprising a plurality of full nodes and/or lightweight nodes. The request may be digitally signed by lightweight node computing device 150 with usage of the private/public key information and through execution of the digital signature algorithms of digital signature information 261.

Furthermore, memory 260 of lightweight node computing device 150 may store blockchain 226. Blockchain 226 stored in memory 260 of lightweight node computing device 150 may include at least block 227n, wherein block 227n represents the most immediate block of blockchain 226. As such, the blockchain 226, which may be a replica or copy of the blockchain of the decentralized P2P network in which lightweight node computing device 150 operates, may be a partial or incomplete copy of the blockchain of the decentralized P2P network. In some instances, however, blockchain 226 may include a blocks 227A, 227B, 227C, . . . 227n, wherein block 227A represents the first block (e.g., genesis block) of blockchain 226 and block 227n represents the most immediate block of blockchain 226. As such, the blockchain 226 may be a full or complete copy of the blockchain of the decentralized P2P network. Each of the blocks within blockchain 226 may include information corresponding to the one or more network functions executed by the decentralized P2P network.

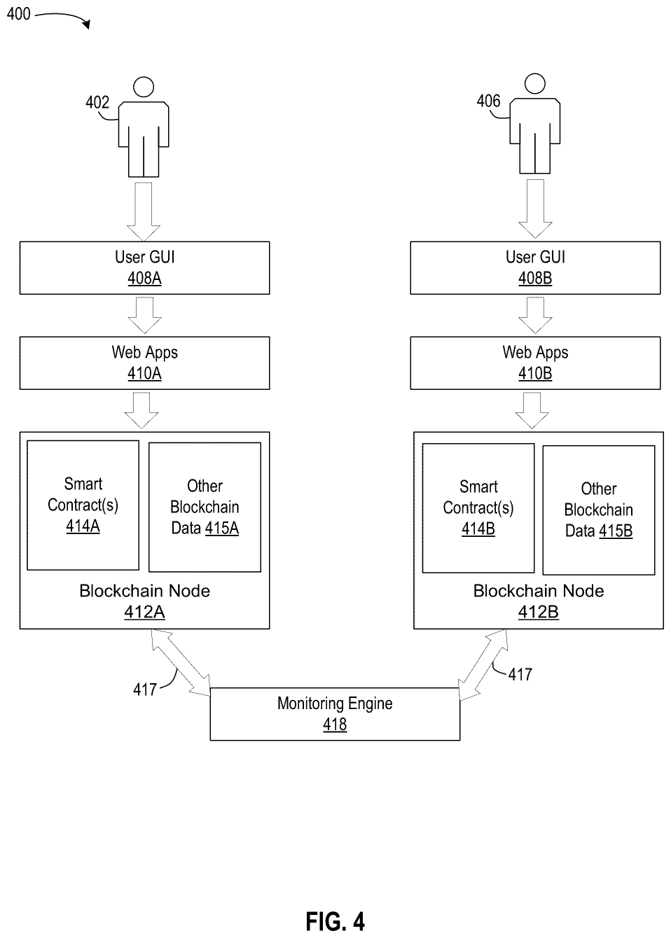

FIG. 3 illustrates an example of a computing system environment 400 that may be used according to one or more illustrative embodiments. The computing system environment 300 is only one example of a suitable computing environment and is not intended to suggest any limitation as to the scope of use or functionality contained in the disclosure. The computing system environment 300 should not be interpreted as having any dependency or requirement relating to any one or combination of components shown in the computing system environment 300.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 3, the computing system environment 300 may include a computing device 301 wherein the processes discussed herein may be implemented. The computing device 301 may have a processor 303 for controlling overall operation of the computing device 301 and its associated components, including random-access memory (RAM) 305, read-only memory (ROM) 307, input/output module or communications module 309, and memory 315. Computing device 301 typically includes a variety of computer readable media. Computer readable media may be any available media that may be accessed by computing device 301 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 301.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 300 may also include optical scanners (not shown). Exemplary usages include scanning and converting paper documents, e.g., correspondence, receipts to digital files.

Although not shown, RAM 305 may include one or more applications representing the application data stored in RAM 305, while the computing device is on and corresponding software applications (e.g., software tasks) are running on the computing device 301.

Communications module 309 may include a microphone, keypad, touch screen, and/or stylus through which a user of computing device 301 may provide input, and may also include one or more of a speaker for providing audio output and a video display device for providing textual, audiovisual and/or graphical output.

Software may be stored within memory 315 and/or storage to provide instructions to processor 303 for enabling computing device 301 to perform various functions. For example, memory 315 may store software used by the computing device 301, such as an operating system 317, application programs 319, and an associated database 321. Also, some or all of the computer executable instructions for computing device 301 may be embodied in hardware or firmware.

Computing device 301 may operate in a networked environment supporting connections to one or more remote computing devices, such as computing devices 341, 351, and 361. The computing devices 341, 351, and 361 may be personal computing devices or servers that include many or all of the elements described above relative to the computing device 301. Computing device 361 may be a mobile device communicating over wireless carrier channel 371.

The network connections depicted in FIG. 3 include a local area network (LAN) 325 and a wide area network (WAN) 329, but may also include other networks. When used in a LAN networking environment, computing device 301 may be connected to the LAN 325 through a network interface, such as LAN interface 323, or to an adapter in the communications module 309. When used in a WAN networking environment, the computing device 301 may include a modem in the communications module 309, a modem separate from the communications module 309, such as modem 327, or other means for establishing communications over the WAN 329, such as the Internet 331 or other type of computer network. It will be appreciated that the network connections shown are illustrative and other means of establishing a communication link between the computing devices may be used. Various well-known protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 319 used by the computing device 301, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 301. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 301. Such a processor may execute computer-executable instructions stored on a computer-readable medium.

By using blockchain nodes/distributed ledgers, information can be communicated in a secure and transparent manner based on blockchain technology described above regarding FIGS. 1, 2, and 3. Blockchain nodes/distributed ledgers have advantages over other forms of communicating data, including, e.g., advantages of immutability, security, traceability, and recovery, described further below.

Immutability refers to something that is unchanging over time, or unable to be changed. In aspects of the disclosure, once data is written to a blockchain, that data cannot be changed—not even by a system administrator or other person having a high level of access. Communicating data via blockchains, as described herein, provides immutability that is particularly advantageous from audit and compliance perspectives relevant to financial transactions. A provider of data that communicates using blockchains as disclosed herein can prove that the data has not been altered. Similarly a recipient of data communicated via blockchains as disclosed herein can be assured that the data has not been altered.

Security is at a very high level with respect to blockchain based communications disclosed herein. By communicating financially sensitive information via blockchain nodes/distributed ledgers, as described herein, this information can be transferred and stored in a highly secure manner.

Traceability is another advantage of blockchain based communications disclosed herein. As examples, transaction audit logs and other traceability features of blockchain based communications disclosed herein provide support for preservation of information and transparency of transactions. As an example, if a party wants to determine any changes made to an agreement, or wants to return to a previous agreement or information, the prior data of the blockchain is readily available and traceable to do so.

Data recovery can be an advantageous feature of blockchain based communications disclosed herein. As described herein, a plurality of blockchain nodes can each maintain a copy of blockchain distributed ledgers in a network.

Decentralization, as enabled by a P2P network enables trust in the system as it does not require any third-party to mediate transactions (e.g., share purchase, sales, transfer, issue) involving different nodes. Transaction data stored in a blockchain is hard to revise and tamper. The blockchain may serve as an immutable and trusted ledger that records and validates every operation during a transaction. Use of signatures may ensure that only authorized users (with a valid key) can initiate/update transactions. Further, the inclusion of smart contracts may provide support for implementing rules as programmable scripts. Encryption may be used to restrict access to data stored in blockchain (which is otherwise available to all nodes) to participants who have the privileges.

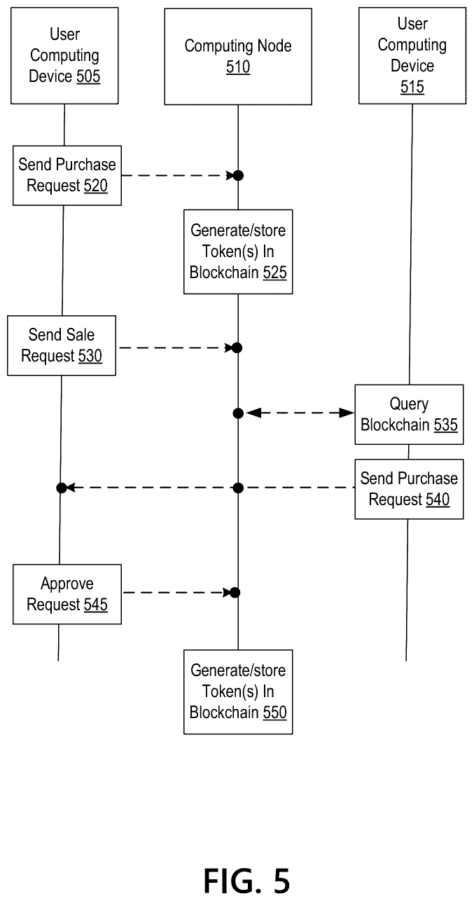

FIG. 4 provides additional examples of aspects of the present disclosure relating to blockchain-based system that may be implemented by one or more of the components in FIGS. 1-3 and/or other components, including other computing devices. FIG. 4 depicts a plurality of users 402 and 406 in a system 400 for sharing smart contracts 414A and/or 414B among a plurality of blockchain nodes 412A and 412B. While only two blockchain nodes 412A and 412B are shown, system 400 can include any number of blockchain nodes across a network. Users 402 and 406 may correspond to users performing a stock trade/transaction, via the blockchain as maintained by the blockchain nodes, using smart contracts 414A and/or 414B.

Each user 402 and 406 can communicate in system 400 via respective user graphical user interfaces (GUIs) or other form of interface, such as GUI 408A (e.g., by user 402) and GUI 408B (e.g., by user 406). The GUIs 408A and 408B can operate in connection with one or more applications, such as respective Web applications (“Web Apps”) 410A and 410B. Users 402 and 406 can use a Web App 410A and 410B, via a respective User GUI 408A and 408B in a computer device, such as computing device 301 described above, to communicate regarding a smart contract 412A and/or 412B stored at a respective blockchain node 412A and/or 412B. The blockchain nodes 412A and/or 412B may comprise blockchain nodes storing blockchain distributed ledgers as described above regarding FIGS. 2A and 3. The smart contract can be stored in a blockchain node 412A. In addition, a copy of the smart contract 412A can be stored as smart contract 414B in blockchain node 412B. Additionally, each of the blockchain nodes 412A and/or 412B may additionally comprise other blockchain data associated with the blockchain distributed ledgers. The blockchain distributed ledgers, in combination with the web application, may form a distributed application for performing one or more transactions (e.g., share purchase, sale, split, passing shareholder resolutions, etc.) as further described herein.

In an arrangement, the User GUI 408A and/or 408B may be provided on a lightweight computing node (e.g., the lightweight computing node 150A or 150B as shown in FIG. 1). The blockchain node 412 A and/or 412B may correspond to a full node (e.g., any one of the full nodes 110A-F as shown in FIG. 1).

In an arrangement, the functions of the web applications may also be performed by a locally stored application on a computing device (e.g., the computing device 301). For example, the locally stored application may present a User GUI 408A and/or User GUI 408B on the computing device via which a user may communicate with the blockchain node 412A and/or 412B.

System 400 can optionally include a monitoring engine 418 in communication with blockchain nodes 412A and 412B via communication links 417. Monitoring engine 418 can be located at any location in a network, including, e.g., in a cryptography machine learning enabled blockchain based apparatus described herein or remote therefrom. Monitoring engine 418 can be used to monitor communications between blockchain nodes throughout a network, including, e.g., blockchain nodes 412A and 412B. As examples, monitoring engine 418 can be used to detect and prevent a “51%” attack such as described above. In some embodiments, monitoring engine 418 can determine whether a party has control of within a threshold amount of blockchains, such as 40%, 45%, 44%, 49%, 50%, or 51%. If control of 50% or more of blockchain in a network by one party is detected, one or more communication links such as described above, e.g., regarding FIG. 4, can switch from using blockchains to using multi-lateral private messages for communications of sensitive data. Similar operations can be performed if control of a threshold amount below 50% (e.g., 49%, 44%, 45%, 40%) of blockchains by one party is detected so as to prevent a “51%” attack. As another example, if monitoring engine 418 detects one party, or a number of related parties, obtains or appears to attempt to obtain a threshold amount of blockchains that could lead to a “51%” or similar attack on the blockchain network, additional monitoring can be performed, such as increasing frequency of monitoring activities or adjusting to an increased level of security, e.g., using permissioned blockchains. If at any point in time a “51%” attack is anticipated or detected, any of the blockchain communications described herein can be switched, either permanently or temporarily, to using multi-lateral private messages for communications. If a threat subsides, multi-lateral private messages for communications can return to blockchain communications.

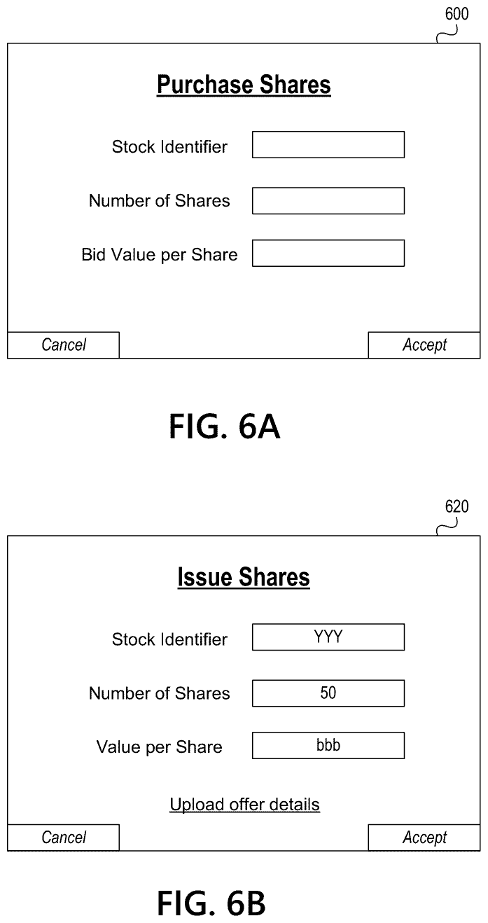

FIG. 5 shows an event sequence for blockchain management, in accordance with one or more example arrangements. Procedure associated with the example event sequence may be performed by one or more devices within the decentralized computing system 100. For example, user computing devices 505 and/or 515 may correspond to lightweight computing node(s) (e.g., the lightweight computing nodes 150 as shown in FIG. 1) of a decentralized computing system. The computing node 510 may correspond to a full computing node (e.g., a full computing node 110 as shown in FIG. 1) of a decentralized computing system. The example event sequence of FIG. 5 may be used for generation of a tokens for shares and transfer of shares between different users (e.g., following a sale transaction to transfer the asset to new clients).

At step 520, the user computing device 505 may send (e.g., transmit), to the computing node 510, a purchase request for purchase of one or more shares (e.g., associated with a stock). The purchase request may correspond to a smart contract operation network function request as described above with respect to FIG. 1. The purchase request may comprise an identifier associated with the shares/stock (e.g., an alphanumeric code, a identifying name/number, etc.), a quantity of shares, and/or a value (e.g., a bid value for each share). The value may in form of units of a cryptocurrency that may be associated with the blockchain ledger. The purchase request may also comprise a wallet identifier/public key of a seller of the shares or a wallet identifier/public key associated with a user who is offering the shares (e.g., via an initial offer/initial public offer (IPO)). The user computing device 505 may additionally indicate, in the purchase request, a wallet identifier/public key associated with the user computing device 505 (e.g., a user of the user computing device 505/a purchaser of the shares).

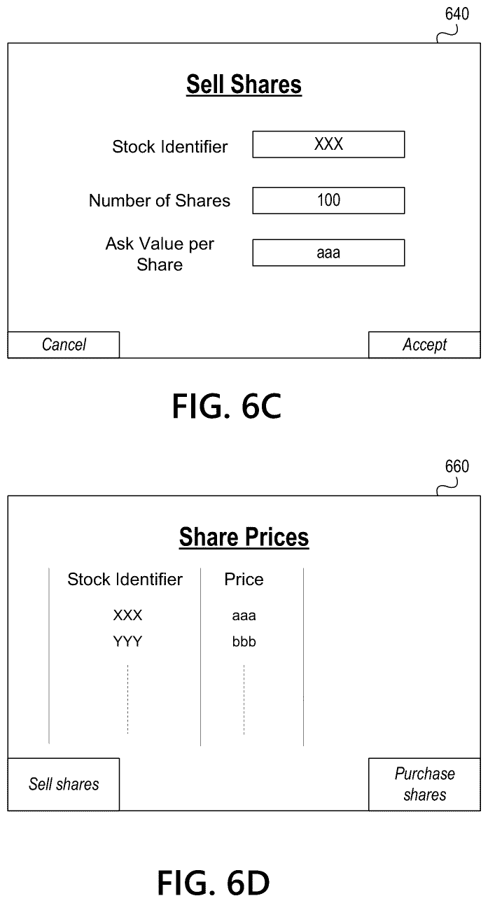

The information included in the purchase request may be input via a GUI (e.g., the user GUI 408A or 408B) at the user computing device 505. FIG. 6A shows an example GUI 600 that may be used by the purchaser to initiate the purchase request of step 520. The example GUI 600 may include fields that may be used to input one or more of the stock identifier, number of shares, and/or a bid value of each share. The example GUI 600 may be provided via the user computing device 505 to the purchaser via a web application or a local application of the user computing device 505.

The shares being purchased by the user of the user computing device 505 may have been a part of an initial offer by a seller. The information associated with the stock being offered may have been input via a GUI (e.g., the user GUI 408A or 408B). FIG. 6B shows an example GUI 620 that may be used by the seller to facilitate an initial offer. The example GUI 620 may include fields that may be used to input one or more of the stock identifier, number of shares, and/or an ask value of each share. A user computing device associated with the seller (not shown in FIG. 5) may display the GUI 620. Based on user input via the GUI 620, the user computing device may send an offer request (comprising the above information in addition to a wallet identifier of the seller) to a computing node (associated with the decentralized computing system). The offer request may be a smart contract operation network function request as described above with respect to FIG. 1. Based on the offer request, the computing node may generate a token including the information in the offer request. The computing node may generate a block, comprising the token, for inclusion into the blockchain. The block may additionally comprise a hash value of a latest block in the blockchain. For example, the generated block may comprise, as a block header, the hash value of the latest (e.g., previous) block as currently stored in the blockchain. Generating the block may further comprise hashing the block to generate a hash value for the block, and appending the hash value to the block. The computing node may store the block in its local copy of the blockchain and, additionally, broadcast the block to other computing nodes for storage in their respective local copies of the blockchain.

At step 525, and based on receiving the purchase request, the computing node 510 may generate a first token for inclusion into the blockchain. The first token may comprise the information included in the purchase request (e.g., stock identifier, quantity of shares, value of each share, wallet identifier of the share purchaser, and/or wallet identifier of seller/share offeror). The computing node 510 may generate a second token for inclusion into the blockchain. The second token may comprise/indicate a wallet identifier of the share purchaser, a latest balance of cryptocurrency (e.g., a reduction in cryptocurrency value) associated with the wallet of the purchaser (e.g., after completion of share purchase), a wallet identifier of the share seller/offerer, and/or a latest balance of cryptocurrency (e.g., an increase in cryptocurrency value) associated with the wallet of the seller/offerer (e.g., after completion of share purchase). The computing node 510 may generate a block, comprising the first and second token, for inclusion into the blockchain. The block may additionally comprise a hash value of a latest block in the blockchain. For example, the generated block may comprise, as a block header, the hash value of the latest (e.g., previous) block as currently stored in the blockchain. Generating the block may further comprise hashing the block to generate a hash value for the block, and appending the hash value to the block. The computing node 510 may store the block in its local copy of the blockchain and, additionally, broadcast the block to other computing nodes for storage in their respective local copies of the blockchain.

The purchase of the shares and the generation of the first and second tokens may be based on execution of a smart contract for stock purchase. The execution of the smart contract for stock purchase may result in a balance sheet transaction for movement of funds (e.g., cryptocurrency) from a wallet identifier associated with the purchaser to a wallet identifier associated with the seller of the shares or a public key of the user who is offering the shares (e.g., in an initial offer). The execution of the smart contract for stock purchase may further cause smart contract operation resulting in association of the shares with the wallet identifier of the purchaser.

At step 530, the user computing device 505 may send (e.g., transmit), to the computing node 510 (or to any other computing node in the decentralized computing system), a sell request for sale of one or more shares (e.g., associated with a stock). The sell request may correspond to a smart contract operation network function request as described above with respect to FIG. 1. The sell request may comprise an identifier associated with the shares/stock (e.g., an alphanumeric code, an identifying name/number, etc.), a quantity of shares, and/or a value (e.g., an ask value for each share). The value may in form of units of a cryptocurrency that may be associated with the blockchain ledger. The sell request may also comprise a wallet identifier/public key of the user of the user computing device 505.

The information included in the sell request may be input via a GUI (e.g., the user GUI 408A or 408B) at the user computing device 505. FIG. 6C shows an example GUI 640 that may be used by the seller to send the sell request. The example GUI 640 may include fields that may be used to input one or more of the stock identifier, number of shares, and/or an ask value of each share. The example GUI 640 may be provided via the user computing device 505 to the purchaser via a web application or a local application of the user computing device 505.

Based on receiving the sell request, the computing node 510 (or any other computing node in the decentralized computing system) may generate a third token for inclusion into the blockchain. The third token may comprise the information included in the sell request (e.g., stock identifier, quantity of shares, value of each share, wallet identifier of the seller corresponding to the user computing device 505). The computing node 510 may generate a block, comprising the third token, for inclusion into the blockchain (e.g., in a manner as described above). Generation of third token may be based on execution of a smart contract in response to receiving the sell request.

Users associated with the decentralized computing system may query the blockchain (e.g., step 535), as stored in any one of the nodes, to review the shares being offered for sale/in an initial offer. For example, if the shares in the sell request (e.g., as sent at step 530) correspond to stock XXX and the ask value for each share of XXX is aaa, the third token may indicate this information. If the shares in an initial offer (e.g., as input via the GUI 620 as shown in FIG. 6B) correspond to stock YYY and the offer value for each share is bbb, a fourth token in the blockchain may indicate this information. Based on querying the blockchain and determining the information in the third token and the fourth token, a GUI (e.g., the user GUI 408A or 408B) at a user computing device may present information regarding the stocks XXX and YYY. FIG. 6D shows an example GUI 660 that may be used to review the shares currently being offered for sale.

Additionally, the GUI 660 may also indicate the latest sale value of stocks that have been purchased. For example, as described above, the first token may include information in a purchase request (e.g., as sent at step 520). The information may comprise the stock identifier of stock being purchased and a value of each share associated with the stock. The GUI 660 may indicate the stock identifier and the value of each share associated with the stock.

At step 540, the user computing device 515 may send (e.g., transmit), to the computing node 510, a purchase request for purchase of one or more shares (e.g., as indicated in the sell request of step 530). For example, a user associated with the user computing device 515 may review the GUI 660 and input information for the purchase request. The information for the purchase request may be input via the GUI 600 as shown in FIG. 6A. The purchase request as sent at step 540 may comprise similar information as the purchase request sent at step 520. The purchase request may comprise an identifier associated with shares/stock (e.g., an alphanumeric code, an identifying name/number, etc.) being request, a quantity of shares, a bid value for each share, a wallet identifier/public key of the user associated with the user computing device 515, and/or a wallet identifier/public key of a seller of the shares (in this case, a user associated with the user computing device 505). Information in the purchase request may be stored as a fifth token in a block of the blockchain (e.g., as described above with respect to step 525). Based on receiving the purchase request, and based on the wallet identifier, the computing node 510 may send an indication of the purchase request to the user computing device 505. The indication of the purchase request may comprise information included in the purchase request from the user computing device 515.

At step 545, the user of the user computing device 505 may review the purchase request from the user computing device 515. For example, a GUI at the user computing device 505 (e.g., the user GUI 408A or 408B) may indicate an identifier associated with shares/stock (e.g., an alphanumeric code, an identifying name/number, etc.) being request, a quantity of shares, a bid value for each share, a wallet identifier/public key of the user associated with the user computing device 515. The user of the user computing device 505 may use the GUI to approve the request or reject the request. An indication of the approval or the rejection may be sent to the computing node 510 (e.g., step 545). In an arrangement, the purchase request and the indication of the approval/rejection may be recorded as tokens in the blockchain. In an arrangement, the user of the user computing device 505 may review the purchase request based on querying the blockchain.

At step 550, and based on receiving an indication of approval from the user computing device 505, the computing node 510 may generate tokens for recording the stock transaction. For example, the computing node 510 may generate a fifth token for inclusion into the blockchain. The fifth token may comprise the information included in the purchase request (e.g., stock identifier, quantity of shares, value of each share, and/or a wallet identifier of the share purchaser (user of the user computing device 515)). The computing node 510 may generate a sixth token for inclusion into the blockchain. The sixth token may comprise a wallet identifier of seller (user of the user computing device 505), the stock identifier, and an updated quantity of shares (of the stock) associated with the wallet of the seller.

The computing node 510 may additionally generate tokens for recording updated cryptocurrency balances of the wallets of the purchaser and the seller. The computing node 510 may generate a seventh token for inclusion into the blockchain. The seventh token may comprise a wallet identifier of the share purchaser and a latest balance of cryptocurrency (e.g., a reduction in cryptocurrency value) associated with the wallet of the purchaser (e.g., after completion of share purchase). The computing node 510 may generate an eighth token for inclusion into the blockchain. The eighth token may comprise a wallet identifier of the share seller and a latest balance of cryptocurrency (e.g., an increase in cryptocurrency value) associated with the wallet of the seller (e.g., after completion of share purchase). The computing node 510 may generate a block, comprising the fifth, sixth, and seventh token, for inclusion into the blockchain (e.g., as described above).

In this manner, the blockchain may store a record of every purchase/sale of stocks, as well as cryptocurrency transactions associated with the stock transaction. Based on querying the blockchain, any computing node associated with the blockchain may determine stocks/quantity of stocks associated with each wallet identifier, as well as a cryptocurrency balance associated with each wallet identifier.

The blockchain, as described above may comprise smart contracts associated with listing shares for purchase, offering shares in an initial offer, sending purchase requests, etc. The smart contracts may be invoked based on messages received from one or more user computing devices in the decentralized computing system.

The blockchain may additionally comprise smart contracts to allow staking of stocks. For example, a user computing device may send a stake request (e.g., a smart contract operation network function request) that may indicate a wallet identifier of a user of the user computing device, a stock identifier of the stock (e.g., associated with the wallet identifier) being staked, a time period for the stake, and a quantity of shares being staked. Based on receiving the stake request, a computing node may execute a smart contract that may reward the wallet identifier with cryptocurrency if the shares are not sold by the user for a duration of the time period. The computing node may generate a token indicating an increase in the cryptocurrency balance of the wallet identifier the user, for example, after the expiration of the time period and based on the wallet identifier being associated with quantity of shares at the expiration of the time period. The computing node may additionally decline any sale requests for the stock associated with the wallet identifier for a duration of the time period.

The blockchain may additionally comprise smart contracts to allow shareholder resolutions. Any user associated with a wallet identifier that holds shares of a stock may initiate a shareholder resolution for the stock. For example, a GUI (e.g., the User GUI 408A and/or 408B) may be used input text of proposed resolutions that may be reviewed by other shareholders. A computing node may generate a token (e.g., based on execution of a smart contract) comprising the text and add the token to the blockchain. The computing node may additionally send the text of the proposed resolution to other users who hold shares of the stock. For example, the computing node may query the blockchain to determine which wallet identifiers are associated with the stock (e.g., hold shares of the stock). The computing node may distribute the resolution via the network to other computing devices. Users with wallet identifiers that hold shares of the stock may view the resolution and approve/disapprove (e.g., via the User GUI 408A and/or 408B) in respective computing devices. An indication of approval or disapproval may be sent (e.g., to a computing node of the decentralized computing system) and recorded as tokens in the blockchain. For example, each indication (e.g., accept, reject, abstain) may be recorded, along with an associated wallet identifier of the user, as a token in the blockchain.

As described above each transaction of shares is recorded as tokens in the blockchain. The historical record of transactions is immutable as per known processes associated with blockchain recordation. Further, the distributed aspect of the blockchain largely removes the possibility of a malicious actor tampering with the transaction record at any one computing node of the decentralized computing system. This provides a secure, tamper-proof record that may be reviewed by a regulatory authority to detect suspicious trading.

The system as proposed herein provides numerous advantages. Currently, a large portion of share trading is done through a dark pool where large financial institutions make trades anonymously, and is not known to public until the trade is executed. The blockchain based system as proposed here will provide transparency where these types of trades cannot be hidden, thereby creating a fair system for trading.

Small businesses or private firms don't need to jump through hoops to get listed through stock exchanges before they can be traded in the open market. Private investment offerings can be done though the same mechanism opening up exponentially large amount of investment offerings to public. Further this can also simplify investing in international companies since an investor doesn't have to go through local brokerages and exchanges for that country.

The blockchain system can also be used to store other information. For example, an enterprise's balance sheet can be made transparent and added to blockchain for verification and publishing the quarterly results.

Assets (e.g., associated with retirement accounts) can be seamlessly transferred using the blockchain system. For example, assets need not be sold in a first account and repurchased in a second account to effect a transfer. Instead, the assets can be moved to a new wallet and a new block with the updated wallet identifier can be added indicating the funds were transferred/moved from one account to another without losing the cost basis. This may speed up the transfer time to few minutes instead of from several weeks.

Various examples as described herein provide a novel, flexible system for token management, in a blockchain environment, for recordation and transfer of assets. The blockchain system may be integrated across multiple organizations enabling seamless transfer of tokens and records. Further, the use of wallet identifiers, associated with an asset, within the tokens themselves may render the system more secure against unauthorized transfer of tokens to a wallet of a malicious actor. An additional layer of security may be provided by enabling only authorized nodes (e.g., full nodes, blockchain management platform 110) to issue or modify tokens.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising
a processor; and
memory storing computer-readable instructions that, when executed by the processor, cause the computing platform to:
receive, from a computing device, a request for stock purchase, wherein the request may indicate a first quantity of shares of the stock, a value for each share, and an identifier associated with the stock;
generate a first token indicating the first quantity of shares, the identifier associated with the stock, and a first wallet identifier associated with a user of the computing device;
create a block, for inclusion into a blockchain, wherein the creating the block comprises hashing at least the first token and a hash value of a first immediately preceding block in the blockchain to generate a first hash value;
transmit the block for addition to respective local copies of the blockchain at other computing nodes;
receive, from a second computing device, a second request for stock purchase, wherein the second request may indicate a second quantity of shares of the stock, a second value for each share, and the identifier associated with the stock;
generate at least two tokens comprising a second token and a third token, wherein:
the second token indicates the second quantity of shares, the identifier associated with the stock, and a second wallet identifier associated with a user of the second computing device; and
the third token indicates a third quantity of shares, the identifier associated with the stock, and the first wallet identifier, wherein the third quantity is equal to a difference between the first quantity and the second quantity;
create a second block, for inclusion into the blockchain, wherein the creating the block comprises hashing at least the second token, the third token, and a hash value of a second immediately preceding block in the blockchain to generate a second hash value; and
transmit the second block for addition to the blockchain.

2. The computing platform of claim 1, wherein the instructions, when executed by the processor, cause the computing platform to:
generate a fourth token indicating a reduction in a cryptocurrency balance associated with the first wallet identifier, wherein the creating the block comprises hashing at least the first token, the fourth token, and the hash value of the first immediately preceding block in the blockchain.

3. The computing platform of claim 2, wherein the cryptocurrency balance is equal to a difference between an initial balance associated with the first wallet identifier and a total value of the stock purchase associated with the request for stock purchase.

4. The computing platform of claim 2, wherein the generating the first token and the fourth token may be based on execution of a smart contract.

5. The computing platform of claim 1, wherein the instructions, when executed by the processor, cause the computing platform to:
receive an indication of a third quantity of shares of the stock associated with the first wallet identifier and a stake duration; and
based on expiration of the stake duration without a reduction in a quantity of shares of the stock associated with the first wallet identifier, generate a fourth token indicating an increase in a cryptocurrency balance associated with the first wallet identifier.

6. The computing platform of claim 1, wherein:
receiving the request for the stock purchase comprises receiving a smart contract operation request for the stock purchase; and
generating the first token is based on execution, of a smart contract stored in the blockchain, in response to receiving the smart contract operation request.

7. The computing platform of claim 1, wherein the second request may comprise an indication of the first wallet identifier, and wherein the instructions, when executed by the processor, cause the computing platform to:
send, based on the indication of the first wallet identifier in the second request, a purchase request to the computing device,
wherein the generating the second token and the third token is based on receiving an indication of approval from the computing device.

8. The computing platform of claim 1, wherein an immediately preceding block is a current latest block of the blockchain.

9. The computing platform of claim 1, wherein the computing platform is associated with a computing node in a network comprising a plurality of computing nodes.

10. The computing platform of claim 1, wherein the instructions, when executed by the processor, cause the computing platform to add the block to a local copy of the blockchain.

11. The computing platform of claim 1, wherein the block comprises a nonce value that, when hashed with a digest that combines the first token and the hash value of the first immediately preceding block, generates the first hash value comprising a predetermined number of consecutive alphanumerical characters at a predetermined position.

12. A method comprising:
receiving, from a computing device, a request for stock purchase, wherein the request may indicate a first quantity of shares of the stock, a value for each share, and an identifier associated with the stock;
generating a first token indicating the first quantity of shares, the identifier associated with the stock, and a first wallet identifier associated with a user of the computing device;
creating a block, for inclusion into a blockchain, wherein the creating the block comprises hashing at least the first token and a hash value of a first immediately preceding block in the blockchain to generate a first hash value;
transmitting the block for addition to the blockchain;
receiving, from a second computing device, a second request for stock purchase, wherein the second request may indicate a second quantity of shares of the stock, a second value for each share, and the identifier associated with the stock;
generating at least two tokens comprising a second token and a third token, wherein:
the second token indicates the second quantity of shares, the identifier associated with the stock, and a second wallet identifier associated with a user of the second computing device; and
the third token indicates a third quantity of shares, the identifier associated with the stock, and the first wallet identifier, wherein the third quantity is equal to a difference between the first quantity and the second quantity;
creating a second block, for inclusion into the blockchain, wherein the creating the block comprises hashing at least the second token, the third token, and a hash value of a second immediately preceding block in the blockchain to generate a second hash value; and
transmitting the second block for addition to the blockchain.

13. The method of claim 12, further comprising:
generating a fourth token indicating a reduction in a cryptocurrency balance associated with the first wallet identifier, wherein the creating the block comprises hashing at least the first token, the fourth token, and the hash value of the first immediately preceding block in the blockchain.

14. The method of claim 13, wherein the cryptocurrency balance is equal to a difference between an initial balance associated with the first wallet identifier and a total value of the stock purchase associated with the request for stock purchase.

15. The method of claim 13, wherein the generating the first token and the fourth token may be based on execution of a smart contract.

16. The method of claim 12, further comprising:
receiving an indication of a third quantity of shares of the stock associated with the first wallet identifier and a stake duration; and
based on expiration of the stake duration without a reduction in a quantity of shares of the stock associated with the first wallet identifier, generating a fourth token indicating an increase in a cryptocurrency balance associated with the first wallet identifier.

17. The method of claim 12, wherein:
the receiving the request for the stock purchase comprises receiving a smart contract operation request for the stock purchase; and
the generating the first token is based on execution, of a smart contract stored in the blockchain, in response to receiving the smart contract operation request.

18. The method of claim 12, wherein the second request may comprise an indication of the first wallet identifier, the method further comprising:
sending, based on the indication of the first wallet identifier in the second request, a purchase request to the computing device,
wherein the generating the second token and the third token is based on receiving an indication of approval from the computing device.

19. The method of claim 12, wherein the block comprises a nonce value that, when hashed with a digest that combines the first token and the hash value of the first immediately preceding block, generates the first hash value comprising a predetermined number of consecutive alphanumerical characters at a predetermined position.

20. A non-transitory computer-readable medium storing computer-executable instructions that, when executed by a computer processor, cause a computing platform to:
receive, from a computing device, a request for stock purchase, wherein the request may indicate a first quantity of shares of the stock, a value for each share, and an identifier associated with the stock;
generate a first token indicating the first quantity of shares, the identifier associated with the stock, and a first wallet identifier associated with a user of the computing device;
create a block, for inclusion into a blockchain, wherein the creating the block comprises hashing at least the first token and a hash value of a first immediately preceding block in the blockchain to generate a first hash value;
transmit the block for addition to respective local copies of the blockchain at other computing nodes;
receive, from a second computing device, a second request for stock purchase, wherein the second request may indicate a second quantity of shares of the stock, a second value for each share, and the identifier associated with the stock;
generate at least two tokens comprising a second token and a third token, wherein:
the second token indicates the second quantity of shares, the identifier associated with the stock, and a second wallet identifier associated with a user of the second computing device; and
the third token indicates a third quantity of shares, the identifier associated with the stock, and the first wallet identifier, wherein the third quantity is equal to a difference between the first quantity and the second quantity;
create a second block, for inclusion into the blockchain, wherein the creating the block comprises hashing at least the second token, the third token, and a hash value of a second immediately preceding block in the blockchain to generate a second hash value; and
transmit the second block for addition to the blockchain.
